(19) United States
(12) Patent Application Publication
(10) Pub. No.: US 2009/0154181 A1
(43) Pub. Date: Jun. 18, 2009

(54) VEHICLE AUXILIARY LIGHTING SYSTEM

(75) Inventors: Hsiang-Yin CHEN, Hsinchu City (TW); Chun-Ming CHEN, Kaohsiung City (TW)

Correspondence Address: Workman Nydegger;1000 Eagle Gate Tower, 60 East South Temple, Salt Lake City, UT, 84111, US

(73) Assignee: ALTEK CORPORATION, Hsinchu (TW)

(21) Appl. No.: 12/026,768

(22) Filed: Feb. 6, 2008

(30) Foreign Application Priority Data
Dec. 14, 2007 (TW) 096148082

(51) Int. Cl. B60Q 1/26; B60Q 1/00

(52) U.S. Cl. 362/464; 362/494

(57) ABSTRACT

A vehicle auxiliary lighting system is used for controlling traveling lighting according to traveling information. The vehicle auxiliary lighting system includes a plurality of light sources disposed on a rear view mirror, a traveling information acquisition device, and a controller. The light sources respectively emit light rays towards different directions, the traveling information acquisition device obtains traveling speed, steering angle, and other information, so as to turn on the light source with a specific angle to emit the light rays according to practical traveling state, thereby further assuring traveling safety.

### CROSS-REFERENCE TO RELATED APPLICATIONS

This non-provisional application claims priority under 35 U.S.C. §119(a) on Patent Application No(s). 096148082 filed in Taiwan, R.O.C. on Dec. 14, 2007, the entire contents of which are hereby incorporated by reference.

### BACKGROUND OF THE INVENTION

1. Field of Invention

The present invention relates to a vehicle auxiliary lighting system, and more particularly to an auxiliary lighting system capable of automatically turning on light sources with different angles with steering of a vehicle.

2. Related Art

Usually, various lamps are disposed on various vehicles, such as head lamps, backup lamps, indicators, and brake lamps. The head lamp is the most primary and important traveling lighting apparatus. When the weather is poor, or it is dark, or during night, the head lamps irradiate the road state in front of the vehicle. When the vehicle changes the traveling direction, the indicator on the left or the right side is turned on to glitter and emit light. When braking, the brake lamps are continuously lightened, for guiding the drivers of other vehicles or walkers, and other users of road to know a traveling tendency of the vehicle. The function of the various lamps is to provide the road state illumination for the driver of the vehicle to clearly master the traveling road state, so as to ensure the extremely good traveling safety, or is used to remind the drivers of other vehicles or walkers to notice the position and the traveling direction of the coming vehicle, so as to prevent traffic accident.

However, because of the limit of the vehicle body, or installation positions of the vehicle lamps, usually, the driver of the vehicle or other users of road cannot clearly master the traveling state due to many visual blind angles, for example, the higher the traveling speed is, the narrows the human visual scope is; and during traveling, if other users of road is on a side of the vehicle, it is impossible for them to view the glitter of the indicator, thereby resulting in traveling danger.

In order to ensure the traveling safety, in Taiwan patent publication No. 230,445, a modified construction of a vehicle rear view mirror is provided, in which light sources are installed on the rear view mirror of the vehicle and glitter synchronously with the indicators, such that other road users can clearly perceive the vehicle traveling state. In addition, in Taiwan patent publication No. M242,401, a vehicle steering lighting structure is provided, in which a control circuit matches with steering auxiliary lights disposed on two sides of the vehicle, such that the vehicle has an auxiliary lighting as the indicator is turned on, so as to increase the traveling safety of the driver.

However, the recently provided vehicle lighting cannot satisfy many states, for example, the visual scope of the driver becomes narrow due to the accelerated traveling speed, but the scope projected by the head lamps is still the same; or when the user changes the direction, A column (between a windscreen and a front door) in the common vehicle structure may shield visual line of the driver, and particularly at night, during steering, it is difficult for the driver of the vehicle to perceive obstacles or other users of road near the A column. The above problems still generate dangers for the driver of the vehicle when the lighting of the vehicle is insufficient or impossible to change with the traveling state.

### SUMMARY OF THE INVENTION

When the vehicle changes the direction, it is easy to result in the visual blind angles of the driver due to poor lighting angle, which seriously threats the traveling safety of the driver. In the prior art, although a modified construction of vehicle rear view mirror and a vehicle steering lighting structure are provided in the action mode of being started as the indicator is turned on, as the driver tends to forget to turn on the indicator when changing the vehicle direction due to carelessness, the vehicle steering lighting structure fails to act, thereby being impossible to ensure the traveling safety of the driver.

In view of the above problem, the present invention provides a vehicle auxiliary lighting system capable of controlling the traveling lighting according to vehicle traveling information, so as to solve the problems or the disadvantages in the prior art.

The vehicle auxiliary lighting system of the present invention includes a plurality of light sources disposed on at least one rear view mirror, a traveling information acquisition device, and a controller. The light sources respectively emit light rays towards different directions, the traveling information acquisition device obtains traveling speed, steering angle, and other information, so as to turn on the light source with a specific angle to emit the light rays according to practical traveling state, thereby further ensuring the traveling safety. Also, the light sources disposed on the rear view mirror can be forced to be turned on manually. In addition, a road state monitoring unit can be adopted together. When the traveling visibility is poor, in addition to the head lamps, the vehicle auxiliary lighting system and the road state monitoring unit are turned on, and the auxiliary lighting light source required by the shooting of the road state monitoring unit is provided, so as to ensure the traveling safety of the vehicle driver.

With the present invention, the vehicle auxiliary lighting system can automatically adjust the turn-on mode of the plurality of light sources disposed on the rear view mirror according to the traveling speed, the steering angle, and other information, or provides the manual manner to force to turn on the light sources on the rear view mirror. In addition, with the road state monitoring unit, the auxiliary lighting light source required during shooting is provided, so as to ensure the traveling safety of the driver of the vehicle.

### BRIEF DESCRIPTION OF THE DRAWINGS

The present invention will become more fully understood from the detailed description given herein below for illustration only, and thus are not limitative of the present invention, and wherein:

FIG. 1 is a block diagram of the vehicle auxiliary lighting system of the present invention;

FIG. 2 is a schematic view of the action of the vehicle auxiliary lighting system of the present invention operated in a manual mode; and

FIG. 3 is a block diagram of the vehicle auxiliary lighting system of the present invention lighting the road state monitoring unit auxiliarily.

### DETAILED DESCRIPTION OF THE INVENTION

In order to have a further understanding of the objective, the construction, the feature, and the function of the present invention, a detailed description is given below with embodiments.

In the vehicle auxiliary lighting system of the present invention, the vehicle refers to the vehicle having two or more wheels.

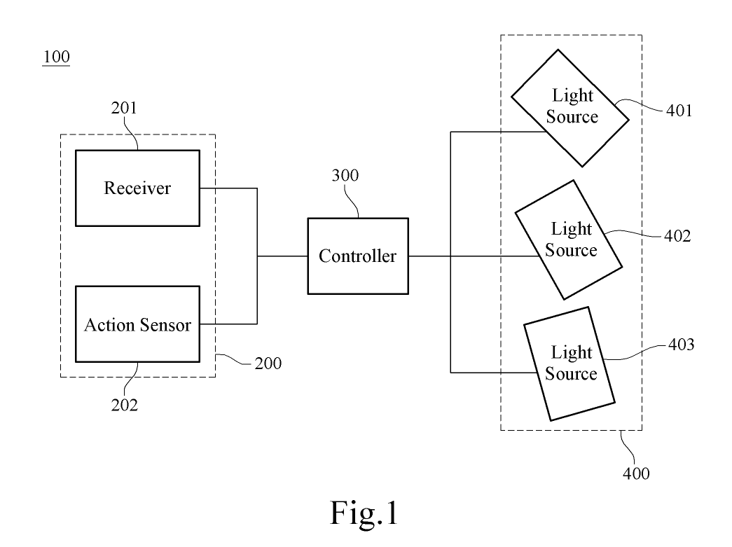

FIG. 1 is a block diagram of the vehicle auxiliary lighting system 100 of the present invention. As shown in the drawing, the vehicle auxiliary lighting system 100 includes a traveling information acquisition device 200, a controller 300, and a plurality of light sources 400 disposed on at least one rear view mirror.

The traveling information acquisition device 200 includes a receiver 201 and an action sensor 202. The receiver 201 is electrically connected to a traveling speedometer of the vehicle, and the action sensor 202 is disposed on a steering wheel of the vehicle, so as to dynamically obtain a traveling speed information and a steering angle information.

The controller 300 is electrically connected to the traveling information acquisition device 200 and the light sources 400. The controller 300 receives the traveling speed information and the steering angle information of the traveling information acquisition device 200, and controls the plurality of light sources 400 disposed on the rear view mirror to individually emit the light rays. As the traveling speed and the steering angle are increased, the controller 300 may adjust to turn on the light source 401, the light source 402, or the light source 403 corresponding to the traveling speed and the steering angle on real time, so as to increase the traveling visual field of the driver of the vehicle.

The light sources 400 disposed on the rear view mirror face different irradiation directions, and is respectively the light source 401, the light source 402, and the light source 403. The light sources 400 can be halide lamps or high efficiency LED light sources. After the vehicle is shun down, the controller 300 delays turn-off of the light sources 400, for illuminating outside environment of the vehicle for the driver when the driver gets down the vehicle.

Please refer to FIG. 1, a first embodiment that the vehicle auxiliary lighting system 100 of the present invention adjusts the turn-on mode of the light sources 400 disposed on the rear view mirror according to the traveling information acquisition device 200 in an automatic mode is shown. As shown in the drawing, when the vehicle travels at night or at the position with poor road state, at this time, the receiver 201 dynamically obtains a traveling speed information through the traveling speedometer, and transmits the traveling speed information to the controller 300. After operational processing of the controller 300, the light source 401 is turned on. As the traveling speed is increased, the controller 300 adjusts to turn on the light source 402 or the light source 403 corresponding to the traveling speed on real time, so as to increase the traveling visual field of the driver. When the driver intends to change the traveling direction of the vehicle, the driver rotates the steering wheel to an angle 1, the action sensor 202 dynamically obtains the steering angle information from the steering wheel, and after the steering angle information is transmitted to the controller 300 for being operational processed, the light source 401 is turned on.

Referring to FIG. 1, a second embodiment that the vehicle auxiliary lighting system 100 of the present invention adjusts the turn-on mode of the light sources 400 disposed on the rear view mirror according to the traveling information acquisition device 200 in an automatic mode is shown. As shown in the drawing, when the driver intends to change the traveling direction of the vehicle, the driver rotates the steering wheel to an angle 2 larger than the angle 1, the action sensor 202 dynamically obtains the steering angle information from the steering wheel, and after the steering angle information is transmitted to the controller 300 for being operational processed, the light source 402 is turned on.

Referring to FIG. 1, a third embodiment that the vehicle auxiliary lighting system 100 of the present invention adjusts the turn-on mode of the light sources 400 disposed on the rear view mirror according to the traveling information acquisition device 200 in an automatic mode is shown. As shown in the drawing, when the driver intends to change the traveling direction of the vehicle, the driver rotates the steering wheel to an angle 3 larger than the angle 2, the action sensor 202 dynamically obtains the steering angle information from the steering wheel, and after the steering angle information is transmitted to the controller 300 for being operational processed, the light source 403 is turned on.

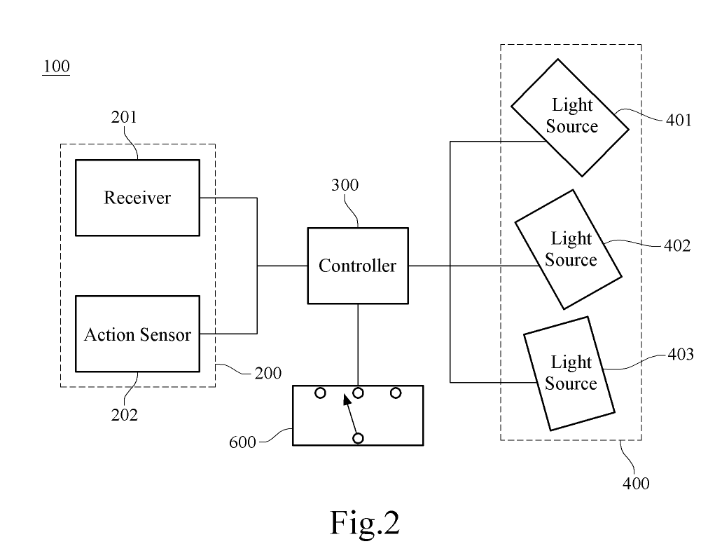

FIG. 2 is a schematic view of the action of the vehicle auxiliary lighting system 100 of the present invention operated in the manual mode. As shown in the drawing, the driver can manually turn on the required light source 401, the light source 402, or the light source 403 through a manually switching module 600 according to requirements.

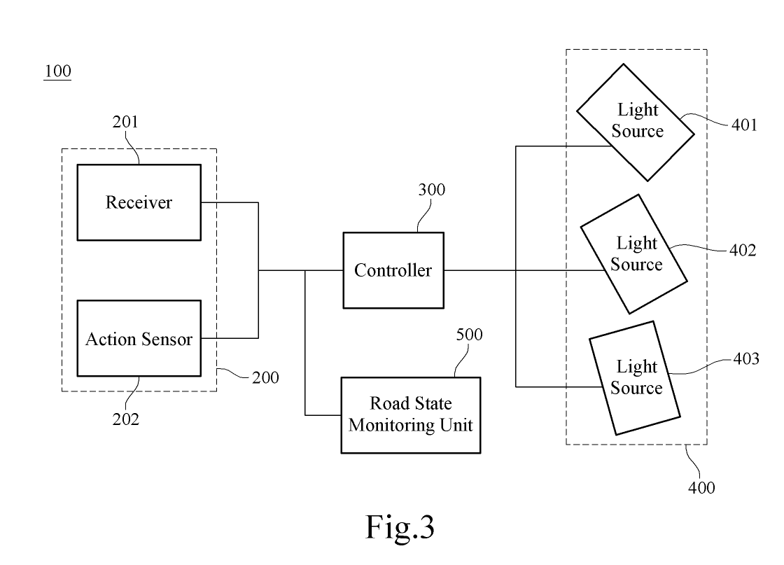

FIG. 3 is a block diagram of the vehicle auxiliary lighting system of the present invention lighting the road state monitoring unit auxiliarily. As shown in the drawing, when the vehicle travels at night or at the position with poor road state, the driver turns on the vehicle auxiliary lighting system 100 and a road state monitoring unit 500. The vehicle auxiliary lighting system 100 provides the auxiliary lighting light source required by the road state monitoring unit 500 during shooting with the traveling state.

What is claimed is:

1. A vehicle auxiliary lighting system, disposed on a vehicle, comprising:
a plurality of light sources, disposed on at least one rear view mirror and facing different irradiation directions;
a traveling information acquisition device, comprising a receiver and an action sensor, wherein the receiver is connected to a traveling speedometer of the vehicle, and the action sensor is disposed on a steering wheel of the vehicle, for dynamically obtaining a traveling speed information and a steering angle information; and
a controller, electrically connected to the traveling information acquisition device and the light sources, wherein the controller receives the traveling speed information and the steering angle information of the traveling information acquisition device, and controls the light sources to individually emit light rays.

2. The vehicle auxiliary lighting system as claimed in claim 1, wherein the light sources are halide lamps.

3. The vehicle auxiliary lighting system as claimed in claim 1, wherein the light sources are high efficiency LED light sources.

4. The vehicle auxiliary lighting system as claimed in claim 1, wherein after the vehicle is shut down, the controller delays turn-off of the light sources, for illuminating outside environment of the vehicle for a driver when the driver gets down the vehicle.
